(19) United States
(12) Patent Application Publication
(10) Pub. No.: US 2022/0283576 A1
(43) Pub. Date: Sep. 8, 2022

(54) AUTOMATIC DIAGNOSIS METHOD, SYSTEM AND STORAGE MEDIUM FOR EQUIPMENT

(71) Applicants: AKTIEBOLAGET SKF, Goteborg (SE); SKF (China) Co Ltd, Shanghai (CN)

(72) Inventors: Gang Cheng, Shanghai (CN); Jim Wei, Shanghai (CN)

(21) Appl. No.: 17/591,063

(22) Filed: Feb. 2, 2022

(30) Foreign Application Priority Data
Mar. 3, 2021 (CN) 202110234925.2

(51) Int. Cl. G05B 23/02

(52) U.S. Cl. CPC G05B 23/0254; G05B 23/0229; G05B 23/024; G05B 23/0235

(57) ABSTRACT

A method and a system for automatic diagnosis of equipment, and a non-volatile processor-readable storage medium storing program instructions for performing the method. The method includes: acquiring a signal associated with operation of the equipment; processing the acquired signal based on automatic diagnosis domain knowledge to extract feature data associated with a current operating state of the equipment, wherein the automatic diagnosis domain knowledge represents data related to a failure mechanism of the equipment; and identifying whether the equipment has an abnormal operating condition based on a similarity between the extracted feature data and historical data associated with a normal operating state of the equipment.

### CROSS-REFERENCE

This application claims priority to Chinese patent application no. 2021 1023 4925.2 filed on Mar. 3, 2021, the contents of which are fully incorporated herein by reference.

### TECHNICAL FIELD

The present disclosure relates to a field of monitoring and fault diagnosis of equipment, and in particular to a method and system for automatic diagnosis of equipment, and a processor-readable storage medium storing program instructions for implementing the automatic diagnosis method.

### BACKGROUND

The present section is intended to introduce the reader to various aspects of the art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

In the industrial field, there are usually various equipment in operation, such as boilers, generator sets, rotating bearings, and so on. In consideration of safety and economy of equipment operation, it is generally required to monitor an operating state of the equipment in real time and to perform predictive analysis on the operating state of the equipment in order to provide early warning of possible failures of the equipment. Early warning of equipment failures is to evaluate the health of the operating state of the equipment, and to provide early warning before the failures occur. Occurrence of equipment failures not only affects efficiency of the enterprise, but also endangers personal safety of the staff. Before an equipment failure occurs, there are often symptoms of the failure, and changes in parameters of the symptoms are often a development process from insignificant to significant, from incomplete to complete. If an automatic fault diagnosis system can be used to accurately predict the state of the equipment when the symptoms of the equipment failure are still not significant, it will be able to buy more troubleshooting time for the operators so they can timely overhaul, maintain and/or repair the equipment, thereby reducing operational risks, avoiding safety accidents, improving equipment operation safety, as well as improving equipment operation efficiency and bringing economic benefits to the enterprise.

However, since these apparatuses are generally complex and highly coupled with each other, and on-site operating environment is also quite different, monitored signals contain a wealth of system information, and failure characteristics are often overwhelmed by noise, making it difficult to identify a current operating state of the equipment simply by analyzing the monitored signals, and even more difficult to provide early warning of possible failures.

### SUMMARY OF THE DISCLOSURE

References in the specification to “one embodiment”, “an embodiment”, “exemplary embodiment”, and “specific embodiment” indicate that the described embodiment may include specific features, structures or characteristics, but each embodiment does not necessarily include the specific features, structures or characteristics. In addition, such phrases do not necessarily refer to the same embodiment. Furthermore, when the specific features, structures, or characteristics are described in combination with an embodiment, it may be considered that implementing such features, structures, or characteristics in combination with other embodiments (whether explicitly described or not) is within the knowledge of those skilled in the art.

According to an aspect of the present principles, a method for automatic diagnosis of equipment is disclosed, comprising: acquiring a signal associated with operation of the equipment; processing the acquired signal based on automatic diagnosis domain knowledge to extract feature data associated with a current operating state of the equipment, wherein the automatic diagnosis domain knowledge represents data related to a failure mechanism of the equipment; identifying whether the equipment has an abnormal operating condition based on a similarity between the extracted feature data and historical data associated with a normal operating state of the equipment.

According to another aspect of the present principles, a system for automatic diagnosis of equipment is disclosed, comprising: one or more sensors to acquire a signal associated with operation of the equipment; one or more processors configured to: process the acquired signal based on automatic diagnosis domain knowledge to extract feature data associated with a current operating state of the equipment, wherein the automatic diagnosis domain knowledge represents data related to a failure mechanism of the equipment; and identifying whether the equipment has an abnormal operating condition based on a similarity between the extracted feature data and historical data associated with a normal operating state of the equipment.

According to yet another aspect of the present principles, a processor-readable storage medium storing program instructions is disclosed, wherein when the program instructions are executed by a processor, the method as described above may be implemented.

According to embodiments of the present principles, performance of an automatic diagnosis system can be improved. Specifically, by integrating a feature extraction function based on automatic diagnosis domain knowledge into an automatic diagnosis framework, it is able to provide the same logic and similar results as provided by human experts, thereby improving interpretability of an automatic diagnosis model; a BallTree-based MSET (multivariate state estimation technique) model with a residual analysis model can realize automatically self-training process, thereby supporting training and prediction of an automatic model and its easy deployment to different customers and locations, facilitating automatic training and deployment of machine learning models, and thus avoiding massive time and effort for offline training and maintenance needed by conventional machine learning; in addition, the machine learning model according to the present disclosure can treatment process data and machine state data together to realize automatic clustering based on process conditions to improve the model prediction accuracy.

### BRIEF DESCRIPTION OF THE DRAWINGS

The present disclosure and other specific features and advantages will be better understood by reading the following description with reference to accompanying drawings, in which:

FIG. 1 shows an architecture of a system for realizing automatic diagnosis of equipment according to a non-limiting embodiment of the present principles;

FIG. 2 shows a schematic flow of a machine learning module in an automatic diagnosis method according to a non-limiting embodiment of the present principles;

FIG. 3 shows a schematic framework of MSET-based state estimation according to a non-limiting embodiment of the present principles;

FIG. 4 shows a failure feature map acquired according to an example of a non-limiting embodiment of the present principles;

FIG. 5 shows an example of a feature vector set constructed according to a non-limiting embodiment of the present principles;

FIG. 6 is a schematic flowchart of a method for automatic diagnosis of equipment according to a non-limiting embodiment of the present principles; and

FIG. 7 is a schematic block diagram of a system for automatic diagnosis of equipment according to a non-limiting embodiment of the present principles.

### DESCRIPTION OF THE EMBODIMENTS

The subject matter will now be described with reference to the accompanying drawings, in which similar reference numerals are used throughout the document to refer to similar elements. In the following description, for the purpose of explanation, many specific details are set forth in order to provide a thorough understanding of the subject matter. However, it is obvious that the present principles can also be implemented without these specific details.

This specification illustrates the principles of the present disclosure. Therefore, it can be understood that, although not explicitly described or illustrated herein, those skilled in the art can design various configurations embodying the present principles of the present disclosure.

The present principles are naturally not limited to the embodiments described herein.

According to an example of the present disclosure, a system and method for fault diagnosis based on similarity are proposed, which can be used to perform condition monitoring and fault diagnosis services for equipment, such as industrial rotating equipment, so as to provide a complete solution. The comprehensive diagnosis system provides automatic data acquisition, automatic diagnosis, and early warning of failures to facilitate repair/maintenance services. The automatic diagnosis process can be realized by using a machine learning module, that is, the use of rich automatic diagnosis domain knowledge and the use of machine learning algorithms as well as a database storing historical operating states of the same type of equipment and/or monitored equipment to realize digital automatic diagnosis, thereby realizing a complete solution for anomaly detection, fault diagnosis, and Remaining Useful Life (RUL) estimation. Optionally, digital twin technology may be used to establish a unique model for each monitored equipment, and realize diagnosis and early warning of various failure modes based on the equipment type, such as bearings, gearboxes, blades, pumps, compressors, generators, centrifuges, and so on. In addition, it is also possible to realize quasi-real-time automatic diagnosis for each monitored equipment based on a cloud solution.

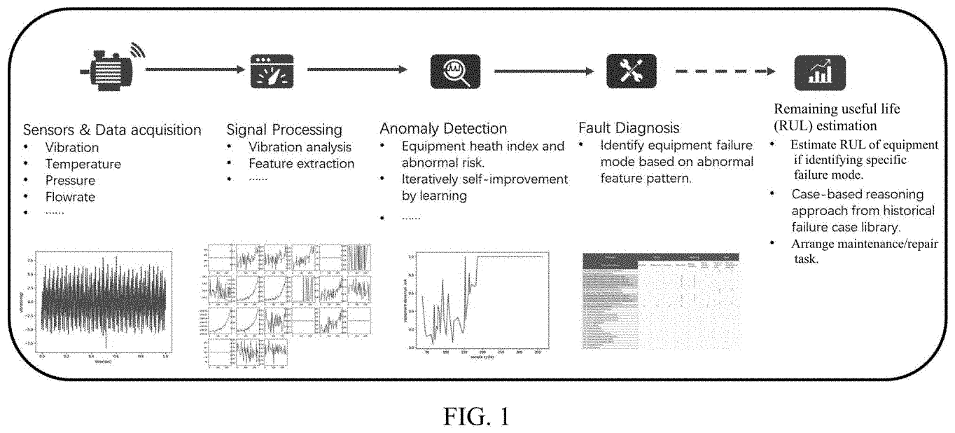

FIG. 1 shows an architecture of an automatic diagnosis system according to an embodiment of the present disclosure, which may include a data acquisition module, a data processing module, and a machine learning module.

Specifically, the data acquisition module may be a general-purpose module for real-time or periodic acquisition of data reflecting an operating state of the equipment or process technology, for example, data such as vibration, temperature, pressure, flow rate and the like.

The data processing module may analyze the acquired data and extract feature data from it. For example, the feature data of the equipment may be extracted based on taxonomy, for example, applications, machines, components, failure modes, condition indicators, etc., which is achieved based on domain knowledge. The feature extraction module may be realized by software based on various historical data related to the equipment, so as to facilitate expansion of the system.

The machine learning module may provide three different levels of automatic diagnosis services based on an output of the feature extraction module, such as anomaly detection, fault diagnosis, and Remaining Useful Life (RUL) estimation service of the equipment. In other words, the machine learning module may include an anomaly detection module and a fault diagnosis module. Optionally, the machine learning module may further include a Remaining Useful Life (RUL) estimation module, which estimates RUL of the equipment based on results of the fault diagnosis. Specifically, the anomaly detection module may detect an abnormal state of the equipment by a BallTree-based MSET anomaly detection algorithm, the fault diagnosis module may detect a specific failure mode related to the abnormal state of the equipment based on a residual ratio of each feature, and the RUL estimation module may estimate the remaining useful life of the equipment based on a historical failure data set as a historical failure case database.

According to an embodiment of the present disclosure, for example, the automatic diagnosis system includes state monitoring and fault diagnosis. Specifically, the automatic diagnosis system includes services such as sensors & data acquisition, signal processing, fault diagnosis and the like. As described above, based on the integrity of sensor data and operating data, three different levels of automatic diagnosis services may be provided, namely, anomaly detection, fault diagnosis, and remaining useful life estimation, in which “anomaly detection” may detect an abnormal equipment state that is not directly related to a failure mode, “fault diagnosis” may detect an abnormal equipment state corresponding to a specific failure type of the equipment, and “remaining useful life estimation” may estimate the remaining useful life of the equipment based on historical failure data. Specifically, various sensors may be used for the type of the equipment to monitor and acquire signals reflecting the operating state of the equipment. For example, an acceleration sensor may be used to monitor vibration of the equipment, a temperature sensor may be used to monitor a temperature of the equipment, a pressure sensor may be used to monitor a pressure state suffered by the equipment, a flow meter may be used to monitor a flow rate through the equipment, and so on. Acquisition of such monitoring signals may be real-time or periodic as needed. After acquiring monitored signals of a relevant equipment, data analysis and processing may be performed on the acquired monitored signals, for example, vibration analysis is performed on vibration signals to extract feature data associated with a current operating state of the equipment. According to an embodiment of the present principles, the acquired monitoring signals may be processed based on automatic diagnosis domain knowledge to extract the feature data associated with the current operating state of the equipment, where the automatic diagnosis domain knowledge represents data related to a failure mechanism of the equipment. For example, when the automatic diagnosis system is used to perform automatic fault diagnosis of a bearing of a wind power generator, a feature signal reflecting an abnormal operation state of the bearing may be extracted from vibration signals acquired by a vibration sensor in real time, for example, a feature representing abnormal operation of the bearing may be extracted from a frequency spectrum curve. As an example, bearing failures may include failures caused by four different abnormal operating states of a bearing inner ring, a bearing outer ring, a rolling element, and a cage. As shown below, among bearing features extracted from an envelope spectrum of the frequency spectrum curve, BPFO represents an abnormal operation feature of the outer ring, BPFI represents an abnormal operation feature of the inner ring, BSF represents an abnormal operation feature of the rolling element, and FTF represents an abnormal operation feature of the cage:

{BPFOᵢ,i=1˜5, BPFIⱼ,j=1˜5, BSFₖ,k=1˜5, FTFₚ,p=1˜5}.

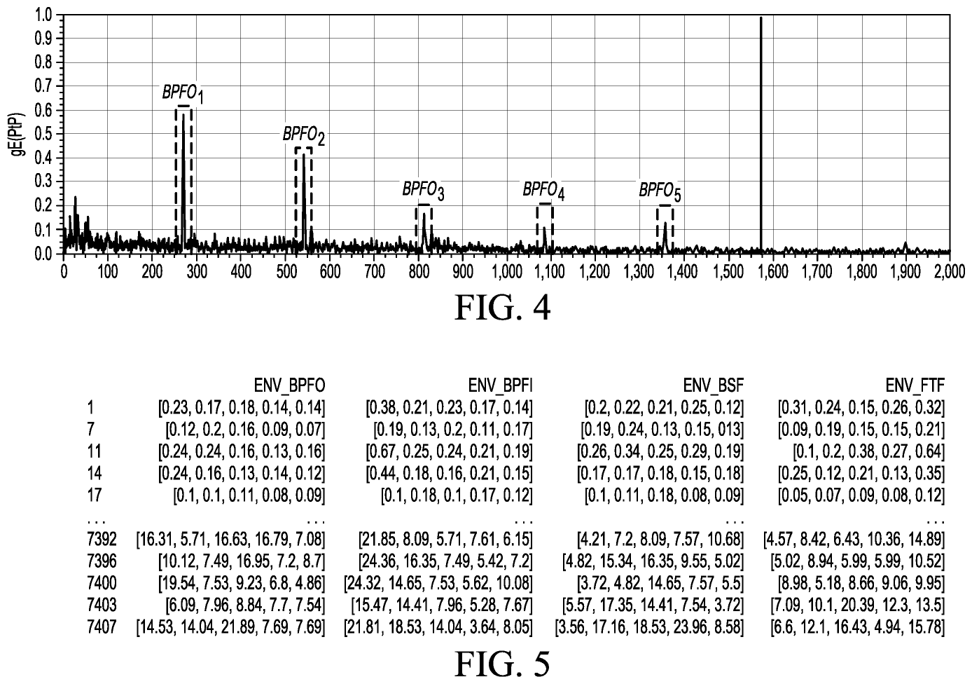

Accordingly, FIG. 4 shows a spectrum pattern and corresponding feature extraction results of BPFO corresponding to a failure of the outer ring.

According to an embodiment of the present disclosure, after the feature data associated with the operating state of the equipment is extracted, whether the equipment has an abnormal operating condition may be identified based on a similarity between the extracted feature data and historical data associated with a normal operating state of the equipment. As an example, an embodiment of the present disclosure adopts a data-driven failure early warning method to analyze and process input data, obtain some feature parameters of the data through the processing, and provide early warning of failures by using the feature parameters. Specifically, an embodiment of the present disclosure is based on a Non-Linear Multivariate State Estimation Technique (MSET), which calculates and estimates various parameters during normal operation, analyzes and compares feature data extracted from actual monitored parameters with healthy data during normal operation of the equipment using the normal state as a benchmark to find a “degree of similarity” with the healthy data, so as to estimate an actual operating state, and the “degree of similarity” there between is determined by a weight vector, which is used to measure a similarity between the actual state and the normal state; and finally compares and analyzes estimated results of the healthy state and the actual operating state, to finally realize automatic diagnosis of failures of the equipment.

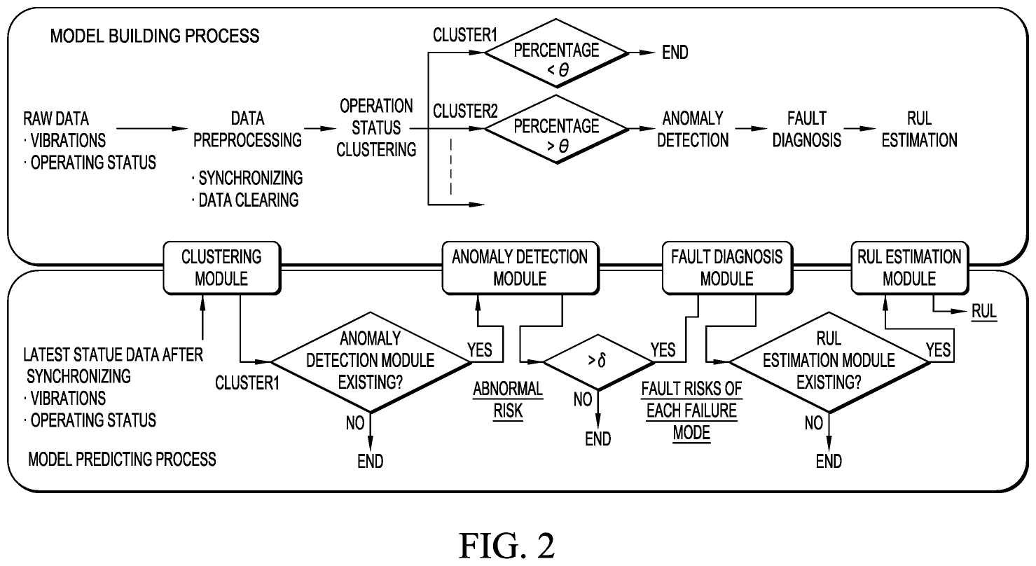

FIG. 2 shows a schematic diagnosis process implemented by a machine learning module according to an embodiment of the present disclosure. This process mainly includes a model building process and a model prediction process. There are two kinds of data, one is data corresponding to process signals, and the other is data corresponding to state monitoring signals. In the model building process, process data is automatically clustered to find a majority of stable process states. For each stable process state, model development is carried out based on the state monitoring signals to build models such as anomaly detection, fault diagnosis and RUL estimation models. For example, for specific applications, diagnostic rules for each machine and failure mode may be set, and features are extracted by using an observer by configuring the diagnostic rules; then a machine learning module such as anomaly detection, fault diagnosis, and RUL estimation modules is automatically built, to realize online automatic operation of the model.

Specifically, as shown in FIG. 2, the module building process mainly includes: acquiring raw data, for example, data reflecting the operating state of the equipment, such as data associated with vibration; preprocessing the data, for example, performing data synchronization and data cleaning, in which data synchronization means to process, such as interpolate, data that may be acquired at different times, so as to synchronize the data to the same time, and data cleaning means to eliminate obviously unreasonable data; clustering operating states of the equipment based on the synchronized and cleaned data, for example, automatically clustering based on a threshold to find a majority of stable process states, and building anomaly detection, fault diagnosis and RUL estimation models for each stable process state based on the state monitoring signals. As an example, the anomaly detection model may be built based on the Multivariate State Estimation Technique (MSET) and a sequential probability ratio algorithm; the fault diagnosis model may be built based on the set diagnosis rules and using residual ratios corresponding to various failure types; the RUL estimation model may be built based on a similarity of historical data corresponding to the failure types, and utilizing various degradation function curves, for example, linear curve function, exponential curve function, and the like. The model predicting process is to predict the operating state of the equipment based on current acquired state data, and using the various models built above, such as the clustering model, the anomaly detection model, the fault diagnosis model and the RUL estimation model, as well as corresponding thresholds, to determine a failure type that may occur in the equipment and estimate RUL of the equipment.

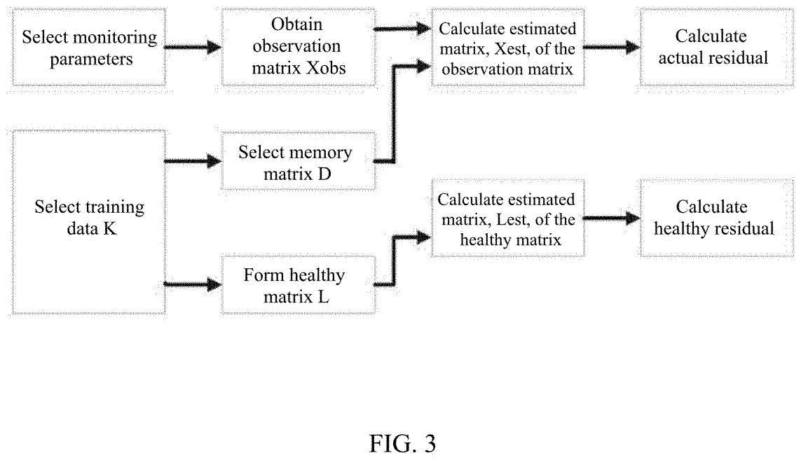

FIG. 3 shows a simplified block diagram of MSET-based state estimation. As described above, the Non-Linear Multivariate State Estimation Technique (MSET) compares current operating data with the generated historical operating state data, calculates and compares a similarity between multiple state variables, so as to realize early automatic diagnosis and early warning of failures. As shown in FIG. 3 an observation matrix Xobs reflecting a current operating state of the equipment is constructed by selecting monitoring parameters and extracting feature data therefrom; a process storage matrix D representing a normal operating state of the equipment is constructed based on historical data associated with the normal operating state of the equipment, for example, by using training data; an estimated matrix Xest for predicting the operating state of the equipment is generated based on the process storage matrix D; and actual residual data of a difference between the observation matrix Xobs reflecting the current actual operating state of the equipment and the estimated matrix Xest reflecting the predicted operating state of the equipment is calculated. On the other hand, sample data is extracted from the historical data associated with the normal operating state of the equipment to form a healthy matrix L, and a difference Lest between the extracted sample data and estimated data generated by predicting the sample data is calculated as healthy residual data corresponding to the historical normal operating state of the equipment. Based on a distribution of the healthy residual data corresponding to the historical normal operating state of the equipment and a distribution of the actual residual data corresponding to the current operating state of the equipment, a probability of abnormal operating condition of the equipment is determined, so as to identify whether the equipment has an abnormal operating condition.

Assuming that a monitored equipment has m time states, and in each time state there are n observation variables forming a state observation vector, the observation matrix for the equipment may be expressed as the following matrix form, where a vector represents a time sequence for a certain observation parameter:

Training data K is healthy states for various observation parameters under normal operation, which must include a full range of dynamic parameters of the equipment, including steady states and drastically changing states, and cannot contain unhealthy data.

From the training matrix K, a part of data that can represent the operating state of the equipment is extracted, which may form the process storage matrix D:

$$D = [ X ( 1 ) X ( 2 ) …X ( m ) ] = [ \begin{matrix}{x}_{1} ( 1 ) & {x}_{1} ( 2 ) & … & {x}_{1} ( m ) \\ {x}_{2} ( 1 ) & {x}_{2} ( 2 ) & … & {x}_{2} ( m ) \\ ⋮ & ⋮ & & ⋮ \\ {x}_{n} ( 1 ) & {x}_{n} ( 2 ) & … & {x}_{n} ( m )\end{matrix} ] \text{?} = [ \begin{matrix}{D}_{11} & {D}_{12} & … & {D}_{1 m} \\ {D}_{21} & {D}_{22} & … & {D}_{2 m} \\ ⋮ & ⋮ & & ⋮ \\ {D}_{n 1} & {D}_{n 2} & … & {D}_{nm}\end{matrix} ] \text{?} \\ \text{?} \text{indicates text missing or illegible when filed}$$

Each column of observation vector in the process storage matrix D represents a normal working state of the equipment. A subspace formed by m historical observation vectors in the process storage matrix after a reasonable selection may represent the entire dynamic process of the normal operation of the equipment. Therefore, the construction of the process storage matrix is essentially a learning and storage process of the normal operating characteristics of the equipment.

As described above, the Multivariate State Estimation Technique (MSET) builds a nonlinear system model based on a non-parametric modeling method, which uses a historical normal operating state data set of the system to learn interrelationships among various variables used to estimate the state of the system. The classical MSET model estimates a new state based on all memory states, which often causes a bad state estimation if the similarity function is not suitable to the state distribution, especially when the system has highly nonlinear state space.

It can be seen that the construction of the process storage matrix D is directly related to the accuracy of similarity-based state estimation. Specifically, the construction of the process storage matrix D is required to cover the full range of dynamic parameters of the normal operation of the equipment, and the number m of states stored therein affects its estimation performance. Generally, the smaller the number of stored states, the worse the estimation effect will be. However, when the number contained in the process storage matrix is too large, due to small fluctuations among a large number of historical parameters, correlation between states will increase, and generation of undesirable noise cannot be suppressed. In addition, the computing time for estimating the equipment is related to the size of the process storage matrix. That is, when the number of states stored in the process storage matrix is large, it will take longer to perform calculation of the state estimation; likewise, when the equipment requires a large number of observation parameters, the calculation time of the state estimation will increase accordingly. To sum up, although a large amount of stored process states can get a better model, it takes a longer time to train, and it will also result in amplification of undesirable noise due to large correlation existed between the large amount of stored process states; while although results for a small amount of stored process states are less accurate, the modeling and estimation process can be performed more quickly.

Therefore, one of goals of optimizing the construction process of the process storage matrix D is to minimize the number of states contained in the process storage matrix in the case that the states in the process storage matrix can cover dynamic changes of the operating state of the equipment in all directions.

To this end, according to an embodiment of the present disclosure, a BallTree-based clustering algorithm is proposed to realize optimization of the construction process of the process storage matrix D. For example, it is possible to perform cluster analysis on the historical normal data of the equipment based on the Ball-Tree clustering algorithm to obtain a cluster center, and select the cluster center to form the process storage matrix of the equipment. In fact, when acquiring the process storage matrix of MSET in a conventional method, original data samples directly form the process storage matrix D without processing, which, although can cover all healthy states of the system, the process of state estimation at this time is equivalent to a noise amplifier due to the large number of states, the short sampling time, and the strong correlation between individual states. However, after clustering historical data using the Ball-Tree clustering algorithm, a process storage matrix D with greatly reduced correlation may be obtained, which effectively suppresses influence of noise on predicted values, and reduces the number of states of the process storage matrix D through the clustering algorithm, thereby reducing the time required for calculation to a certain extent.

To this end, according to an embodiment of the present disclosure, it is proposed to construct the process storage matrix D representing the normal operating state of the equipment using a Ball-Tree clustering algorithm, based on historical data associated with the normal operating state of the equipment. For example, historical healthy state data in MSET is arranged in a matrix form, each column vector of the matrix represents a specific state or measurement, and the number of rows in the matrix is equal to a total observation amount corresponding to the specific state. A state set at a given time tⱼ is defined as a vector Y(tⱼ),

Y(tⱼ)=[y₁(tⱼ),y₂(tⱼ),y₃(tⱼ), . . . , yₙ(tⱼ)]^{T}

where yᵢ(tⱼ) represents a measurement of state i at time tⱼ.

Then the process storage matrix D=[Y(t₁), Y(t₂), Y(t₃), . . . , Y(tₘ)].

Compared with the traditional MEST method, the D matrix of the BallTree-based MSET is dynamically generated by clustering each historical healthy state data using the Ball-Tree clustering algorithm according to a similarity between the input state and each historical healthy state.

For example, the process storage matrix of MSET generated based on the Ball-Tree clustering algorithm may be expressed as:

D(Yᵢₙ)=[Y(t₁),Y(t₂),Y(t₃), . . . , Y(tₘ)]

where [t₁, t₂, t₃, . . . , tₘ]=BallTree(Yᵢₙ, m).

In other words, according to the embodiment of the present disclosure, the process storage matrix D representing the normal operating state of the equipment is constructed by using m historical observation vectors extracted from historical healthy data of the equipment using the Ball-Tree clustering algorithm, which may represent the entire dynamic process of the normal operation of the equipment. As an example of the present disclosure, when constructing the process storage matrix D, one or more of the following options may be considered: a size of the process storage matrix D may be less than half of a total historical normal data set; data in the process storage matrix D should be distributed as uniformly as possible in the entire state space; in order to ensure the uniformity of data distribution in the constructed process storage matrix D, a threshold parameter a called minimum similarity may be set to reduce the problem of increased correlation between states caused by small fluctuation among a large amount of historical state data, thereby suppressing generation of undesirable noise and also avoiding serious non-uniformity of data distribution in the process storage matrix D.

In summary, according to an embodiment of the present disclosure, a scheme of using a ball tree to construct an MSET process state matrix is proposed, in which based on historical normal operation data of the equipment, a Ball-Tree clustering algorithm is used to query data with large similarity to select a cluster center, so as to construct an adaptive process storage matrix.

As described above, an input of the MSET model is a new observation vector of the monitored equipment at a certain moment, and its output is a predicted quantity Yₑₛₜ of the observation vector. In fact, Yᵢₙ is an observation matrix with a certain length of time formed by system observation. MSET compares a current observation state with operating states in the process storage matrix and generates a weight, and estimates a current system state accordingly. The generated current system state estimated matrix Yₑₛₜ is a matrix of the same size as Yᵢₙ, which may be calculated by the dot product of the process storage matrix and the weight, as shown in the following equation:

Yₑₛₜ=D(Yᵢₙ)·W

where an m-dimensional weight vector W=[w₁,w₂, . . . wₘ]^{T} is generated for any input observation vector Yᵢₙ, so that

Yₑₛₜ=Y(t₁)·w₁+Y(t₂)·w₂+ . . . +Y(tₘ)·wₘ.

It can be seen that the prediction output of the MSET model is a linear combination of m historical observation vectors in the process storage matrix.

If the new input observation vector of the model is obtained in the normal working state of the equipment, since the process storage matrix covers the normal working state space of the equipment, the new observation vector will always be similar to some historical observation vectors in the process storage matrix, and thus a combination of these similar historical observation vectors may provide high-precision predicted values for the input observation vector, in which the accuracy of model prediction may be measured by a residual between a predicted value of a certain variable and an actual measured value of the variable. However, when the working state of the equipment changes and there is a hidden risk of failure, due to the change of dynamic characteristics, the input observation vector will deviate from the normal working space, and is not similar to the historical observation vectors in the process storage matrix D, a combination of the historical observation vectors cannot construct its corresponding accurate prediction value, which will lead to a decrease in prediction accuracy and an increase in residual error.

The weight represents a size of a similarity measurement between the state estimation and the process storage matrix, which may be solved by selecting a weight matrix W to minimize the sum of squares of a residual ε=Yᵢₙ−Yₑₛₜ between the input observation vector and the output prediction vector of the MSET model.

As an example, Min ε=min [(Yᵢₙ−D·W)^{T}·(Yᵢₙ−D·W)],

Then, the weight may be expressed as:

W=(D^{T}·D)⁻¹·(D^{T}·Yᵢₙ).

Since there is a certain correlation between state data of most systems, correlation between data will cause the matrix in the above equation to be irreversible, which limits the solution of the weight. For this reason, a similarity operator ⊗ based on a similarity principle may be used to replace the dot product, and the weight may be characterized by calculating similarities between data states, so as to solve the matrix irreversibility caused by data correlation. Using the similarity operator ⊗ instead of the dot product, it may be obtained that:

W=(D^{T}⊗D)⁻¹·(D^{T}⊗Yᵢₙ).

In addition, in order to reduce the system's sensitivity to noise caused by possible complex coupling correlations of normal historical data of the equipment, a concept of ridge regularization may be introduced when calculating the weight and estimated values, and an identity matrix may be introduced in the calculation of the weight to achieve its de-correlation:

W=(D^{T}⊗D+λI)⁻¹·(D^{T}⊗Yᵢₙ).

where the symbol ⊗ represents the similarity operation, λ is a ridge regularization parameter (X>0), and I is an identity matrix.

As an example, residual data corresponding to the current operating state of the equipment may be expressed as:

Rᵢₙ=|Yₑₛₜ−Yᵢₙ|.

In summary, according to the above-mentioned various embodiments of the present disclosure, the Ball-Tree clustering algorithm may be used to construct the process storage matrix D representing the normal operation state of the equipment based on historical data associated with the normal operation state of the equipment; the estimated data Yₑₛₜ used to predict the operating state of the equipment may be generated based on the constructed process storage matrix D; and the difference between the extracted feature data Yᵢₙ and the estimated data Yₑₛₜ is calculated as the residual data corresponding to the current operating state of the equipment.

FIG. 5 shows a process storage matrix constructed according to an example of the present disclosure, in which data corresponding to historical normal operating states of a bearing of a wind power generator is extracted by using the Ball-Tree algorithm, and vectors corresponding to the extracted data are integrated into MSET algorithm to build an anomaly detection model Model_{wind-generator-bearing-mset}.

According to an embodiment of the present disclosure, in the proposed automatic diagnosis method, sample data L is extracted from historical data associated with a normal operating state of the equipment, and a difference between the extracted sample data and estimated data Lest generated by predicting the sample data is calculated as healthy residual data R_{healthy} corresponding to historical normal operating states of the equipment. In other words, the residual data R_{healthy} reflects a difference between the historical normal operating data of the equipment and its predicted value.

Optionally, the automatic diagnosis method may further include: determining a probability of abnormal operating condition of the equipment by using Sequential Probability Ratio Test (SPRT) based on a distribution of residual data corresponding to the historical normal operating state of the equipment and the distribution of residual data corresponding to the current operating state of the equipment, to identify whether the equipment has an abnormal operating condition.

That is, after obtaining the actual residual data and healthy residual data of the input state, the probability of abnormal operating condition of the equipment may be determined by using Sequential Probability Ratio Test (SPRT) based on the distribution of these data, thereby identifying whether the equipment has an abnormal operating condition. SPRT is a testing technique based on binary hypothesis, which assumes that residual signals meet two prerequisites: (1) state samples are independent and identically distributed; (2) state samples follow a prior distribution with unknown parameters.

As described above, the actual residual and healthy residual of the equipment obtained based on MSET are in matrix form, but commonly used statistical data processing methods are usually performed on one-dimensional vector samples. In order to solve this problem, it is necessary to preprocess the residual data to reduce the actual residual and healthy residual to one-dimensional vectors, and then perform the statistical data processing method on the one-dimensional vectors. Specifically, according to an embodiment of the present disclosure, the dimension of the residual is reduced by introducing a weight vector K=[k₁, k₂, . . . , kₙ], where kᵢ represents a weight ratio of state i. Thus, the actual residual data and healthy residual data of the equipment after dimensionality reduction may be expressed as:

\hat{R}ᵢₙ=Rᵢₙ·K

\hat{R}_{healthy}=R_{healthy}·K.

In order to analyze abnormal changes in the operating state of the equipment, accurately perform an early warning of abnormal operation of the equipment, and reduce the rate of false warnings and missed warnings, the embodiment of the present disclosure may use SPRT to analyze the residual data.

By assuming that the residual obeys a normal distribution, the input residual value may be tested by mean and variance based on the SPRT method.

According to the present disclosure, it is possible to decide which hypothesis to accept based on a ratio between a function of the state residual that does not obey the normal distribution and a function of the state residual that obeys the normal distribution. For example, as an example, the probability ratio shown below may be used to decide which hypothesis to accept:

$$γ ( \overline{R} ) = \frac{{F}_{i} ( {R}_{k} \vert {H}_{i} )}{G ( {R}_{k} \vert {H}_{0} )} , i = 1 , … , 4$$

where Fᵢ(Rₖ|Hᵢ) is a likelihood function for observing that the state residual Rₖ after dimensionality reduction does not obey the normal distribution N (μ₀,σ₀²), and G (Rₖ|H₀) is a likelihood function for observing that the state residual Rₖ after dimensionality reduction obeys the normal distribution N (μ₀, σ₀²).

(1) Original hypothesis H₀: when the equipment is operating normally, the healthy residual data reflecting the normal operating state of the equipment conforms to a normal distribution with a mean value of μ₀ and a variance of σ₀²;

(2) Alternative hypothesis Hᵢ (i=1, . . . 4): a distribution of the actual residual data reflecting the operating state of the equipment when the equipment is operating abnormally.

As an example, corresponding upper limit value and lower limit value may be set, and the hypothesis decision may be determined by comparing the probability ratio with the set upper limit value and lower limit value, respectively.

For example, when the above probability ratio is less than the set lower limit value, it is determined that the current operating state of the equipment is normal, and when the above probability ratio is greater than the set upper limit value, it is determined that the current operating state of the equipment is abnormal.

In addition, the above-mentioned similarity model constructed by BallTree-based MSET selects some representative states to construct the process storage matrix. When the equipment is operating normally, a high-precision state estimation may be obtained; but when the equipment state has sudden changes, such as large load changes, some isolated points that are significantly higher than a normal estimated error value may appear. In addition, when the equipment is in a failure state, its parameter vectors undergo a dynamic mutation, and the observed state points will also shift accordingly to deviate from the normal working state space, and deviate from the space model constructed by the process storage matrix. In this case, due to reduced similarity, corresponding predicted residuals will also increase significantly and a time sequence distribution of the residuals will be significantly different from a normal operating condition. In order to extract such time sequence information, according to an embodiment of the present disclosure, a sliding window residual statistics method may be used to extract a mean and variance of residuals in the window, thereby ensuring real-time and accuracy of abnormal early warning while ensuring reliability of the abnormal early warning method, and reducing the probability of false warnings and error warnings. In other words, a sliding window, i.e., a reduced residual sequence {Rᵢ|i=1, . . . , L} is used to extract residual data.

As an example, after obtaining the probability that the equipment may be abnormal, it may be compared with a preset threshold value to determine whether the equipment has an abnormal operating condition.

According to an embodiment of the present disclosure, in the case of identifying that the equipment has an abnormal operating condition, residual ratios corresponding to various failure types are calculated based on a distribution of residual data corresponding to the current operating state of the equipment; and a failure type that the equipment may have in the future is determined based on the calculated residual ratios.

As an example, the following algorithm may be used to determine the failure type that the equipment may have in the future:

$${Risk}_{{mode}_{k}} = \frac{{\sum }_{i ∈ {mode}_{k}} {Residual}_{i}}{{\sum }_{i ∈ all} {Residual}_{i}}$$

As an example, based on the model constructed for automatic diagnosis of the bearing of the wind power generator as shown in FIG. 5, a predicted result is calculated according to newly acquired features, and a residual ratio is calculated. For example, a failure probability calculated based on the newly acquired features is 82%, and the result of the model residual distribution is as follows:

$$\frac{[ 5.1 , 3.2 , 2.2 , 1.0 , 2.0 ,}{\begin{matrix}BPFO \\ 76.8 \%\end{matrix}} \frac{0.6 , 0.5 , 0.2 , 0.4 , 0.4 ,}{\begin{matrix}BPFI \\ 12.0 \%\end{matrix}} \frac{0.23 , 0.35 , 0.22 , 0.24 , 0.42 ,}{\begin{matrix}BSF \\ 8.4 \%\end{matrix}} \frac{0.16 , 0.05 , 0.1 , 0.04 , 0.1 ]}{\begin{matrix}FTF \\ 2.8 \%\end{matrix}}$$

Based on the residual result, it can be seen that a residual ratio corresponding to BPFO is 76.8%, so the reason for a future failure of the equipment is more likely to be related to BPFO (failure of the bearing outer ring).

According to an embodiment of the present disclosure, based on the determined failure type that the equipment may have in the future, a similarity between the extracted feature data and historical data corresponding to the failure type may be used to estimate remaining useful life (RUL) of the equipment. The remaining useful life (RUL) refers to a period from the current time to the end of the useful life of the equipment when it is determined that the operating state of the equipment is abnormal. According to an embodiment of the present disclosure, a healthy indicator of equipment operation is obtained through abnormal detection of the operation state of the equipment, for example, the above-mentioned BallTree-based MSET prediction and the process of determining the probability of abnormal operation of the equipment using SPRT; whether the current operating condition of the equipment is in the normal phase or in the abnormal phase is determined, for example, the above-mentioned process of determining the failure type that the equipment may have in the future based on the ratio of the obtained residual data; in the case of determining that the current operating condition of the equipment is in the abnormal phase, the remaining useful life (RUL) of the equipment is estimated to formulate maintenance and/or repair strategy of the equipment, so as to realize automatic diagnosis and health management of the equipment.

Generally, RUL mainly includes the following methods: physical model-based methods, statistical model-based methods, and data-driven methods. Considering diversity of application environment and operating conditions of industrial equipment, it may be difficult to establish a universal physical model and statistical model. According to an embodiment of the present disclosure, a data-driven RUL estimation method is adopted to realize estimation of the remaining useful life of the equipment. The equipment may be grouped according to equipment types and application environment; then, operating conditions of each subgroup are automatically clustered; finally, a similarity-based data-driven method is used to estimate the remaining useful life (RUL) of the equipment.

According to an embodiment of the present disclosure, RUL estimation for the equipment mainly includes: clustering of operating states; detection of abnormal operating states of the equipment, and equipment health state diagnosis that determines whether the current operating condition of the equipment is in the normal phase or in the abnormal phase; similarity-based RUL estimation.

Considering that the useful life of the equipment is closely related to the operating state of the equipment, it is necessary to segment data associated with the operating state of the equipment. The data related to the operating state may be segmented based on pre-defined rules, or by using a clustering model. When the data related to the operating state is segmented based on a clustering model, an input of the clusterer is a state list, and an output is an operation index/label. Various clustering algorithms commonly used in the field may be used to segment the data related to the operating state, including but not limited to K-means clustering, DBSCAN clustering, BIRCH clustering algorithm, etc.

According to an embodiment of the present disclosure, after segmenting the operating state of the equipment, the equipment is diagnosed using an anomaly detection (MSET+SPRT) method to realize a two-stage state diagnosis, whose output is normal or abnormal. In the case that the diagnosis result is abnormal, a similarity-based algorithm may be used to estimate the remaining useful life (RUL) of the equipment. The similarity-based algorithm is a data-driven method, and its basic principle is that similar inputs usually produce similar outputs, which requires only a small number of similar samples to achieve prediction of the remaining useful life (RUL) of the equipment based on a similarity between a reference sample and a predicted object.

According to an embodiment of the present disclosure, the similarity-based RUL estimation takes a current state of the equipment as an input, and searches recorded or stored historical data for a state similar to the input current state. Specifically, a state similar to the input state S_{new} is searched using recorded or stored historical data about the operating state of the equipment, for example, in a case library that stores historical data corresponding to various operating states of the equipment.

For example, search for a similar state Sₖ in {Caseᵢ|i=1 . . . k}, set a similarity threshold and consider a weight of corresponding states. If the maximum similarity between each state in caseᵢ and the input state S_{new} is greater than the threshold, use caseᵢ to estimate RUL, otherwise ignore caseᵢ, that is, set a weight corresponding to caseᵢ to 0. As an example, for the weight of caseᵢ, it may also be considered to modify the weight using residual life estimated based on caseᵢ. For example, if the residual life estimated based on caseᵢ is large, the weight corresponding to caseᵢ is small. In other words, if the RUL estimated based on caseᵢ is small, caseᵢ will be more important. This modification of the weight is mainly to avoid prediction delay.

Therefore, according to an embodiment of the present disclosure, based on the determined failure type that the equipment may have in the future, the remaining useful life (RUL) of the equipment is estimated by using a similarity between the extracted feature data and historical data corresponding to the failure type. In addition, as an example, at least one set of historical data similar to the extracted feature data is searched in the historical data corresponding to the failure type; the remaining useful life (RUL) of the equipment is estimated by using weighted average based on remaining useful life of the equipment corresponding to the at least one set of historical data.

In summary, according to the principles of the present disclosure, a comprehensive automatic diagnosis solution is designed by combining a typical equipment condition monitoring tool with a machine learning module. This scheme combines domain knowledge and a data-driven model to realize diagnosis. As described above, the automatic diagnosis domain knowledge represents data related to the failure mechanism of the monitored equipment, for example, including but not limited to, vibration analysis, typical working condition indicators, machine performance rate estimation and the like for various machine types and failure modes. The machine learning module in the solution realizes self-training and automatic prediction processing based on historical data, personnel diagnosis results and even maintenance records.

According to the embodiments of the present disclosure, an automatic diagnosis system is realized through deep integration of automatic diagnosis domain knowledge and data-driven methods; in addition, all model building and development processes are automatic and easy to scale up; at the same time, three levels of diagnostic functions of anomaly detection, fault diagnosis and remaining useful life (RUL) prediction are integrated on one comprehensive platform, or distributed on different platforms.

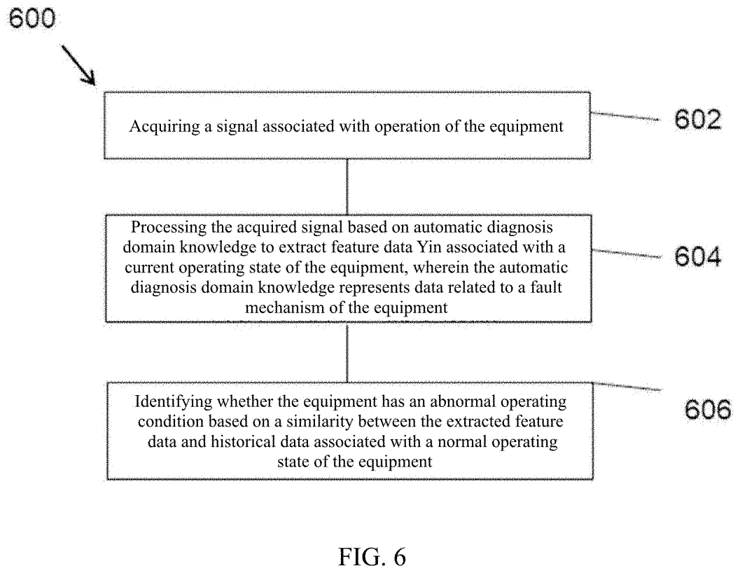

FIG. 6 shows a schematic flowchart of a method for automatic diagnosis of equipment according to a non-limiting embodiment of the present principles. Specifically, as shown in FIG. 6, the method 600 includes: step 602, acquiring a signal associated with operation of the equipment; step 604, processing the acquired signal based on automatic diagnosis domain knowledge to extract feature data associated with a current operating state of the equipment, where the automatic diagnosis domain knowledge represents data related to a failure mechanism of the equipment; and step 606, identifying whether the equipment has an abnormal operating condition based on a similarity between the extracted feature data and historical data associated with a normal operating state of the equipment.

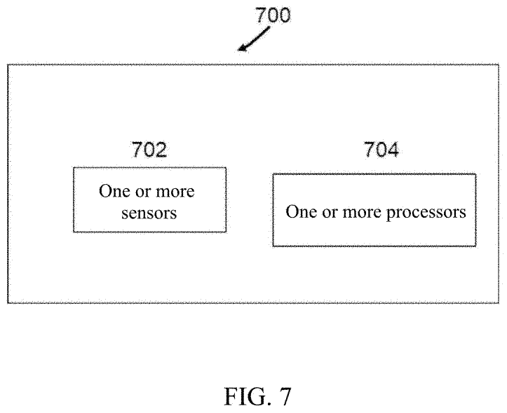

According to another aspect of the present principles, a system for automatic diagnosis of equipment is also disclosed. As shown in FIG. 7, the system 700 includes: one or more sensors 702 that acquire a signal associated with operation of the equipment; and one or more processors 704 configured to: process the acquired signal based on automatic diagnosis domain knowledge to extract feature data Yᵢₙ associated with a current operating state of the equipment, where the automatic diagnosis domain knowledge represents data related to a failure mechanism of the equipment; and identify whether the equipment has an abnormal operating condition based on a similarity between the extracted feature data and historical data associated with a normal operating state of the equipment.

According to another aspect of the present principles, a processor-readable storage medium storing program instructions is also disclosed. When the program instructions are executed by a processor, the method as described may be implemented.

The embodiments described herein may be implemented by, for example, a method or process, an apparatus, a computer program product, a data stream, or a signal. Even if only a single implementation is discussed in the context (e.g., only discussed as a method or equipment), implementation of discussed features may also be implemented in other forms (e.g., a program). The apparatus may be implemented with appropriate hardware, software, and firmware, for example. The method may be implemented in, for example, an apparatus such as a processor, and the processor generally refers to a processing device, including, for example, a computer, a microprocessor, an integrated circuit, or a programmable logic device. The processor also includes communication devices, such as smart phones, tablets, computers, mobile phones, portable/personal digital assistants (“PDAs”), and other devices that facilitate communication of information between end users.

In addition, the methods may be implemented by instructions executed by a processor, and such instructions (and/or data values generated by the implementation) may be stored on a processor-readable medium, for example, an integrated circuit, a software carrier , or other storage devices; other storage devices may be, for example, hard disks, compact disks (CDs), optical disks (e.g., DVDs, commonly referred to as digital versatile disks or digital video disks), random access memory (RAM), or read-only memory (ROM). The instructions may form an application program tangibly embodied on a processor-readable medium. The instructions may be in, for example, hardware, firmware, software, or a combination thereof. The instructions may be found in, for example, an operating system, a separate application program, or a combination thereof. Therefore, the processor may be characterized by, for example, a device configured to perform a process and a device including a processor-readable medium (such as a storage device) having instructions for performing a process. Furthermore, a processor-readable medium may store, in addition to or in lieu of instructions, data values produced by an implementation.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

What is claimed is:

1. A method for automatic diagnosis of equipment, comprising:
acquiring a signal associated with operation of the equipment;
processing the acquired signal based on automatic diagnosis domain knowledge to extract feature data associated with a current operating state of the equipment, wherein the automatic diagnosis domain knowledge represents data related to a failure mechanism of the equipment;
identifying whether the equipment has an abnormal operating condition based on a similarity between the extracted feature data and historical data associated with a normal operating state of the equipment.

2. The method of claim 1, further comprising:
in a case of identifying that the equipment has an abnormal operating condition, calculating residual ratios corresponding to various failure types based on a distribution of residual data corresponding to the current operating state of the equipment; and
determining a failure type that the equipment may have in the future based on the calculated residual ratios.

3. The method of claim 2, further comprising:
estimating, based on the determined failure type that the equipment may have in the future, remaining useful life of the equipment by using a similarity between the extracted feature data and historical data corresponding to the failure type.

4. The method of claim 3, wherein:
a probability of abnormal operating condition of the equipment is determined by using Sequential Probability Ratio Test SPRT based on a distribution of residual data corresponding to a historical normal operating state of the equipment and the distribution of the residual data corresponding to the current operating state of the equipment, to identify whether the equipment has an abnormal operating condition.

5. The method of claim 1, wherein:
a probability of abnormal operating condition of the equipment is determined by using Sequential Probability Ratio Test SPRT based on a distribution of residual data corresponding to a historical normal operating state of the equipment and the distribution of the residual data corresponding to the current operating state of the equipment, to identify whether the equipment has an abnormal operating condition.

6. The method claim 1, wherein:
a process storage matrix that represents the normal operating state of the equipment is constructed by using a Ball-Tree clustering algorithm based on the historical data associated with the normal operating state of the equipment.

7. The method of claim 6, wherein:
estimated data for predicting an operating state of the equipment is generated based on the constructed process storage matrix; and
a difference between the extracted feature data and the estimated data is calculated as the residual data corresponding to the current operating state of the equipment.

8. The method claim 1, wherein:
sample data is extracted from the historical data associated with the normal operating state of the equipment;
a difference between the extracted sample data and estimated data generated by predicting the extracted sample data is calculated as residual data corresponding to a historical normal operating state of the equipment.

9. The method claim 3, wherein:
sample data is extracted from the historical data associated with the normal operating state of the equipment;
a difference between the extracted sample data and estimated data generated by predicting the extracted sample data is calculated as residual data corresponding to a historical normal operating state of the equipment.

10. The method of claim 3, wherein:
at least one set of historical data similar to the extracted feature data is searched in the historical data corresponding to the failure type;
the remaining useful life of the equipment is estimated by using weighted average based on remaining useful life of the equipment corresponding to the at least one set of historical data.

11. A non-volatile processor-readable storage medium storing program instructions, wherein when the program instructions are executed by a processor, the method according to claim 1 is implemented.

12. A system for automatic diagnosis of equipment, comprising:
one or more sensors configured to acquire a signal associated with operation of the equipment;
one or more processors configured to:
process the acquired signal based on automatic diagnosis domain knowledge to extract feature data associated with a current operating state of the equipment, wherein the automatic diagnosis domain knowledge represents data related to a failure mechanism of the equipment; and
identify whether the equipment has an abnormal operating condition based on a similarity between the extracted feature data and historical data associated with a normal operating state of the equipment.

13. A system for automatic diagnosis of equipment, comprising:
a first sensor physically associated with a piece of equipment and configured to acquire a first signal associated with operation of the piece of equipment;
a second sensor physically associated with the piece of equipment and configured to acquire a second signal associated with operation of the piece of equipment;
at least one processor configured to:
process the acquired first and/or second signal based on automatic diagnosis domain knowledge to extract feature data associated with a current operating state of the piece of equipment, wherein the automatic diagnosis domain knowledge represents data related to a failure mechanism of the piece of equipment;
identify whether the equipment has an abnormal operating condition based on a similarity between the extracted feature data and historical data associated with a normal operating state of the equipment; and
output an output signal indicative of an expected failure type and/or a remaining useful life of the piece of equipment.
